(19) United States
(12) Patent Application Publication
(10) Pub. No.: US 2019/0019011 A1
(43) Pub. Date: Jan. 17, 2019

(54) SYSTEMS AND METHODS FOR IDENTIFYING REAL OBJECTS IN AN AREA OF INTEREST FOR USE IN IDENTIFYING VIRTUAL CONTENT A USER IS AUTHORIZED TO VIEW USING AN AUGMENTED REALITY DEVICE

(71) Applicant: Tsunami VR, Inc., Del Mar, CA (US)

(72) Inventors: David ROSS, San Diego, CA (US); Alexander F. HERN, Del Mar, CA (US)

(21) Appl. No.: 16/000,846

(22) Filed: Jun. 5, 2018

Related U.S. Application Data
(60) Provisional application No. 62/533,097, filed on Jul. 16, 2017.

(51) Int. Cl. G06K 9/00; G06T 7/70; G06K 9/62; G06T 19/00

(52) U.S. Cl. CPC G06K 9/00214; G06T 19/006; G06K 9/6215; G06T 7/70

(57) ABSTRACT

Identifying real objects in an area of interest for use in identifying virtual content a user is authorized to view using an augmented reality device. Particular methods and systems determine a set of real objects that are near a first position of a first augmented reality device, determine, from the set of real objects, a first subset of real objects that are associated with virtual content that the first augmented reality device is permitted to display, and for each real object in the first subset of real objects, transmit virtual content associated with that real object to the first augmented reality device.

### TECHNICAL FIELD

This disclosure relates to virtual reality (VR), augmented reality (AR), and mixed reality (MR) technologies.

### BRIEF DESCRIPTION OF THE DRAWINGS

FIG. 1A and FIG. 1B depict aspects of a system on which different embodiments are implemented for identifying real objects in an area of interest for use in identifying virtual content a user is authorized to view using an augmented reality device.

FIG. 2 depicts a method for identifying real objects in an area of interest for use in identifying virtual content a user is authorized to view using an augmented reality device.

FIG. 3 is a block diagram of system operation for filtering objects based on a location of the user in one embodiment.

### DETAILED DESCRIPTION

This disclosure relates to different approaches for identifying real objects in an area of interest for use in identifying virtual content a user is authorized to view using an augmented reality device.

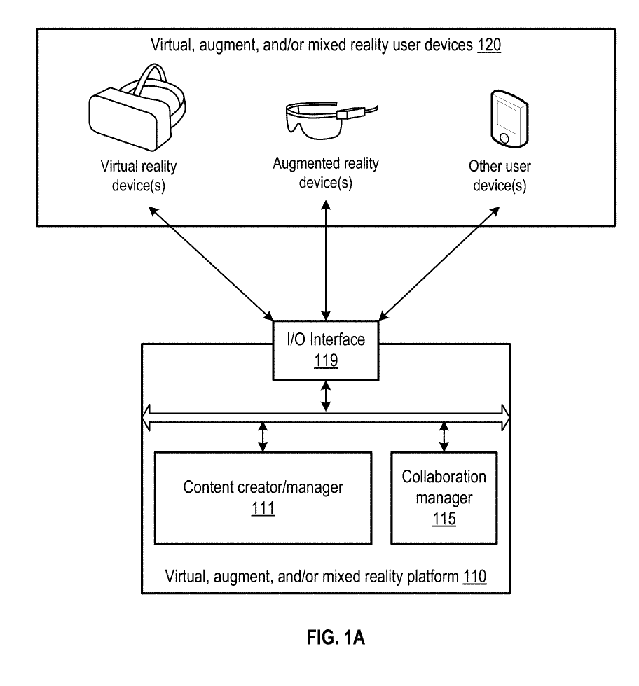

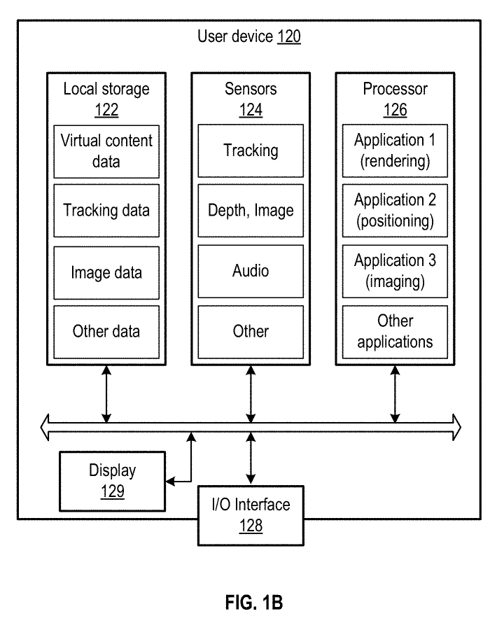

FIG. 1A and FIG. 1B depict aspects of a system on which different embodiments are implemented for identifying real objects in an area of interest for use in identifying virtual content a user is authorized to view using an augmented reality device. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for identifying real objects in an area of interest for use in identifying virtual content a user is authorized to view using an augmented reality device are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for identifying real objects in an area of interest for use in identifying virtual content a user is authorized to view using an augmented reality device.

### Identifying Real Objects in an Area of Interest for Use in Identifying Virtual Content a User is Authorized to View Using an Augmented Reality Device

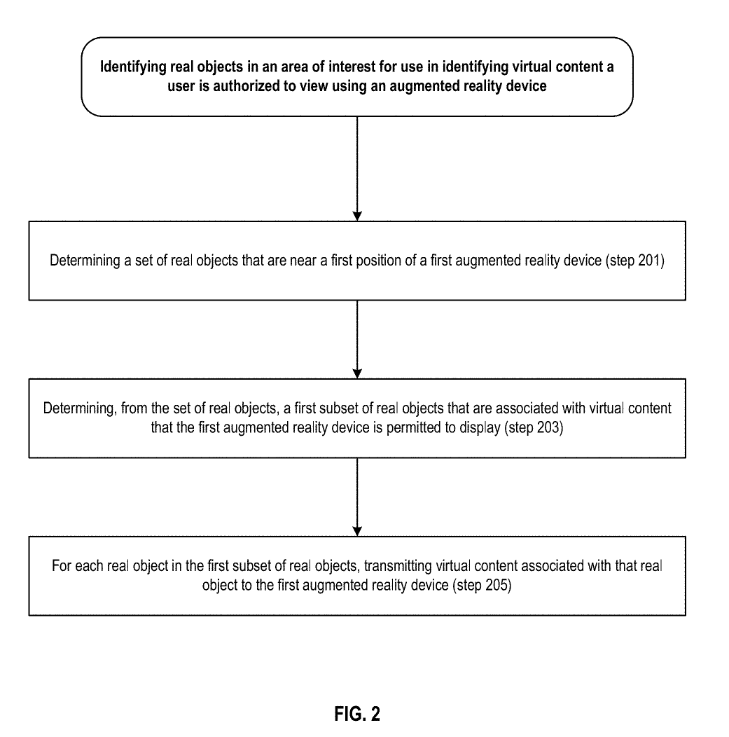

FIG. 2 depicts a method for identifying real objects in an area of interest for use in identifying virtual content a user is authorized to view using an augmented reality device.

Performance of the method shown in FIG. 2 comprises: determining a set of real objects that are near a first position of a first augmented reality device (step 201); determining, from the set of real objects, a first subset of real objects that are associated with virtual content that the first augmented reality device is permitted to display (step 203); and for each real object in the first subset of real objects, transmitting virtual content associated with that real object to the first augmented reality device (step 205).

In one embodiment of the method, each real object in the set of real objects is near the first position when the first augmented reality device receives one or more signals containing identifiers that identify each of the real objects in the set of real objects. One approach where each real object in the set of real objects is near the first position when the first augmented reality device receives one or more signals containing identifiers that identify each of the real objects in the set of real objects comprises: receiving, after the first augmented reality device arrives at the first position, one or more signals containing identifiers that identify real objects; and including, in the set of real objects, the real objects with identifiers contained in the signals. By way of example, each signal may originate from the real object it identifies, or from a local beacon in range of the first augmented reality device.

In one embodiment of the method, each real object in the set of real objects is near the first position when that real object is within a predefined distance from the first position. One approach where each real object in the set of real objects is near the first position when that real object is within a predefined distance from the first position comprises: determining the first position of the first augmented reality device; for each real object of a plurality of real objects, retrieving a position of that real object from a data storage device; and including, in the set of real objects, only real objects from the plurality of real objects that have positions that are within the predefined distance from the first position.

In one embodiment of the method, each real object in the set of real objects is near the first position when that real object is within a first area that includes the first position. One approach where each real object in the set of real objects is near the first position when that real object is within a first area that includes the first position comprises: determining the first position of the first augmented reality device; identifying one or more real areas from a data storage device (e.g., examples of areas include: geographic areas with defined boundaries, buildings, floors in buildings, other types of venues, or other types of known areas); and determining a real area of the one or more real areas includes the first position of the first augmented reality device, wherein the first area is the determined real area.

In one embodiment of the method, each real object in the set of real objects is near the first position when a sensor of the first augmented reality device detects that real object. One approach where each real object in the set of real objects is near the first position when a sensor of the first augmented reality device detects that real object comprises: receiving, at the first augmented reality device, one or more wireless signals that were respectively transmitted from one or more real objects (e.g., detecting using known transceiving circuitry); and including, in the set of real objects, the one or more real objects that transmitted the one or more wireless signals received at the first augmented reality device). Another approach where each real object in the set of real objects is near the first position when a sensor of the first augmented reality device detects that real object comprises: capturing, using an optical sensor (e.g., camera or other optical sensor) of the first augmented reality device, one or more images of one or more real objects; for each image of a real object from the one or more images of the one or more real objects, (i) determining if that image of that real object matches a stored model of a real object from a plurality of stored models of real objects, and (ii) if that image of that real object matches a stored model of a real object, including, in the set of real objects, the real object of that image.

In one embodiment of the method, determining a first subset of real objects that are associated with virtual content that the first augmented reality device is permitted to display comprises: determining a permission level of the first augmented reality device; and for each real object in the set of real objects: (i) determining if a permission level associated with the virtual content associated with that real object matches the permission level of the first augmented reality device; (ii) if the permission level associated with the virtual content associated with that real object matches the permission level of the first augmented reality device, including the real object in the first subset of real objects; and (iii) if the permission level associated with the virtual content associated with that real object does not match the permission level of the first augmented reality device, excluding the real object from the first subset of real objects. By way of example, the permission level of the first augmented reality device may be a permission level of a first user operating the first augmented reality device.

In one embodiment of the method, determining a first subset of real objects that are associated with virtual content that the first augmented reality device is permitted to display comprises: determining a condition associated with the first augmented reality device; and for each real object in the set of real objects: (i) determining if the condition associated with the first augmented reality device matches a condition that applies to the virtual content associated with the real object; (ii) if the condition associated with the first augmented reality device matches the condition that applies to the virtual content associated with the real object, including the real object in the first subset of real objects; and (iii) if the condition associated with the first augmented reality device does not match the condition that applies to the virtual content associated with the real object, excluding the real object from the first subset of real objects. By way of example, the condition associated with the first augmented reality device matches the condition that applies to the virtual content associated with the real object when: a day and/or a time of day during which the first augmented reality device is at the first position matches a day and/or time when the virtual content may be displayed; a presentation capability of the first augmented reality device (e.g., a resolution or a size of a display of the first augmented reality device, a rendering capability of the first augmented reality device, or other presentation characteristic of the first augmented reality device) matches or exceeds a minimum presentation capability required to display the virtual content; or other approaches.

In one embodiment of the method, determining a first subset of real objects that are associated with virtual content that the first augmented reality device is permitted to display comprises: determining one or more preferences of a first user operating the first augmented reality device; and for each real object in the set of real objects: (i) determining if a type of the virtual content associated with the real object matches at least one of the one or more preferences of the first user; (ii) if the type of the virtual content associated with the real object matches at least one of the preferences of the first user, including the real object in the first subset of real objects; and (iii) if the type of the virtual content associated with the real object does not match at least one of the preferences of the first user, excluding the real object from the first subset of real objects. By way of example, types of virtual content include subject matter, content, text, images, or other types of content.

In one embodiment of the method, determining a first subset of real objects that are associated with virtual content that the first augmented reality device is permitted to display comprises: determining one or more filter settings designated for the first augmented reality device or a first user operating the first augmented reality device; and for each real object in the set of real objects: (i) determining if the virtual content associated with the real object passes the one or more filter settings; (ii) if the virtual content associated with the real object passes the one or more filter settings, including the real object in the first subset of real objects; and (iii) if the virtual content associated with the real object does not pass the one or more filter settings, excluding the real object from the first subset of real objects.

By way of example, the one or more filter settings may include a first job function of the first user, and the virtual content associated with the real object passes the one or more filter settings only when the virtual content can be displayed to a user with the first job function.

By way of example, the one or more filter settings may include a first permission level of the first user, and the virtual content associated with the real object passes the one or more filter settings when the virtual content can be displayed to a user with the first permission level.

By way of example, the one or more filter settings may include a first type of preference of the first user, and the virtual content associated with the real object passes the one or more filter settings when the virtual content can be displayed to a user with the first type of preference.

By way of example, the one or more filter settings may include identifiers of one or more real objects designated by a first user of the first augmented reality device, and the virtual content associated with the real object passes the one or more filter settings when an identifier of the real object associated with the virtual content is among the identifiers of the one or more real objects designated by the first user.

In one embodiment of the method, the virtual content for each real object in the first subset of real objects includes a displayable name of that real object, and the method comprises: displaying, on a display of the first augmented reality device, each name of each real object in the first subset of real objects.

In one embodiment of the method, the virtual content for each real object in the first subset of real objects includes a displayable name of that real object, and the method comprises: displaying, on a display of the first augmented reality device, a first name of a first real object at a position that appears to be within a predefined distance from the first real object.

In one embodiment of the method, the virtual content for each real object in the first subset of real objects includes a displayable visual designator for that real object, and the method comprises: displaying, on a display of the first augmented reality device, a first visual designator of a first real object at a position that appears to be on the first real object or within a predefined distance from the first real object. By way of example, the visual indicator may be text, an icon, an arrow, an animated virtual object, a label, a color overlaying the real object, a boundary around the real object, or other visual designator.

In one embodiment of the method, the virtual content for each real object in the first subset of real objects includes a virtual representation of internal components of the real object, and the method comprises: displaying, on a display of the first augmented reality device, a first virtual representation of a first set of internal components of a first real object to overlay the first real object or at a position that appears to be within a predefined distance from the first real object.

In one embodiment of the method, the method comprises: receiving, from a first user of the first augmented reality device, one or more designations of one or more real objects; and including, in the set of real objects, the one or more real objects designated by the one or more designations from the first user.

In one embodiment of the method, the method comprises: receiving, from a first user of the first augmented reality device, one or more designations of one or more real objects that are in view of the first user; and including, in the first subset of real objects, the one or more real objects designated by the one or more designations from the first user.

In one embodiment of the method, the method comprises: receiving new virtual content generated during a first time period by a first user of the first augmented reality device; determining a first real object from the first subset of real objects to associate with the new virtual content; storing the new virtual content in association with the first real object; transmitting, during a second time period, the new virtual content to the second augmented reality device; and displaying, during the second time period, the new virtual content on a display of the second augmented reality device.

In one embodiment of the method, the method comprises: receiving new virtual content generated by a first user of the first augmented reality device in association with a first real object that is not included in the first subset of real objects; storing the new virtual content in association with the first real object; transmitting the stored virtual content to the second augmented reality device; and displaying the new virtual content on a display of the second augmented reality device.

In one embodiment of the method, the method comprises: determining that the set of real objects are near a second position of a second augmented reality device; determining, from the set of real objects, a second subset of real objects that are associated with virtual content that the second augmented reality device is permitted to display; and for each real object in the second subset of real objects, transmitting virtual content associated with that real object to the second augmented reality device, wherein a first number of real objects in the first subset of real objects is different than a second number of real objects in the second subset of real objects.

In one embodiment of the method, the first augmented reality device includes a head-mounted display or a mobile phone with a display for displaying virtual content the first augmented reality device receives.

By way of example, a position of a user device may be a coordinate position, a physical space, or other type of location.

The above method and its embodiments can alternatively be used for virtual objects in virtual areas instead of real objects.

### Other Embodiments

A user wearing an augmented reality device can walk into a location and receive information about objects in the location. However, without some type of constraint, this can lead to an overuse of bandwidth as the augmented reality device receives, or attempts to receive, data on all of the objects in the location.

There is a need to reduce the bandwidth used when using augmented or mixed reality devices to identify objects in a location.

A purpose of embodiments disclosed in this section is to be able to have software that can identify objects in a user's view but to optimize that identification process by providing the algorithm with a list of objects that are known to be in the vicinity.

One embodiment is a method for identifying objects in an area using augmented reality (“AR”). The method includes entering a radius of interest with an AR device, wherein the radius of interest comprises a plurality of objects. The method also includes identifying the radius of interest using a location detection means. The method also includes transmitting the location to a server. The method also includes comparing the location of the user and the location of each of the plurality of objects to generate to a list of objects within the radius of interest. The method also includes identifying the plurality of objects within the radius of interest to the user on a display screen of the AR device.

Another embodiment is a method for identifying objects in an area using mixed reality (“MR”). The method includes entering a radius of interest with a MR device, wherein the radius of interest comprises a plurality of objects. The method also includes identifying the radius of interest using a location detection means. The method also includes transmitting the location to a server. The method also includes comparing the location of the user and the location of each of the plurality of objects to generate to a list of objects within the radius of interest. The method also includes identifying the plurality of objects within the radius of interest to the user on a display screen of the MR device.

Yet another embodiment is a system for identifying objects in an area using augmented reality (“AR”). The system comprises an AR head mounted display (“HMD”) device, a client device, a server, and a database. The client device is in communication with the AR device and the server. The client device is configured to identify a radius of interest using a location detection means when a user enters the radius of interest wearing the AR HMD device, wherein the radius of interest comprises a plurality of objects. The client is configured to transmit the location to a server. The server is configured to compare the location of the user and the location of each of the plurality of objects to generate to a list of objects within the radius of interest. The server is configured to identify the plurality of objects within the radius of interest to the user on a display screen of the AR HMD device.

Yet another embodiment is a system for identifying objects in an area using mixed reality (“MR”). The system comprises a MR head mounted display (“HMD”) device, a client device, a server, and a database. The client device is in communication with the MR device and the server. The client device is configured to identify a radius of interest using a location detection means when a user enters the radius of interest wearing the MR HMD device, wherein the radius of interest comprises a plurality of objects. The client is configured to transmit the location to a server. The server is configured to compare the location of the user and the location of each of the plurality of objects to generate to a list of objects within the radius of interest. The server is configured to identify the plurality of objects within the radius of interest to the user on a display screen of the MR HMD device.

In one embodiment of the methods and systems of this section, the location detection means is at least one of GPS, RFID, WiFi, magnetic fields, cellular triangulation or a location identification beacon. In one embodiment of the methods and systems of this section, the method comprises changing the radius of interest by moving to a new location. In one embodiment of the methods and systems of this section, the method comprises comparing the plurality of objects to a list of objects provided by the user. In one embodiment of the methods and systems of this section, the method comprises a client device in communication with the AR device. In one embodiment of the methods and systems of this section, the client device comprise at least one of a personal computer, a HMD, a laptop computer, a tablet computer or a mobile computing device. In one embodiment of the methods and systems of this section, identifying the plurality of objects comprises overlaying identification information for each object of the plurality of objects. In one embodiment of the methods and systems of this section, the method comprises comprising identifying and marking new objects. In one embodiment of the methods and systems of this section, the method comprises filtering the number of objects of the plurality of objects. In one embodiment of the methods and systems of this section, the method comprises filtering comprises using a target algorithm that reduces the number of objects of the plurality of objects. In one embodiment of the methods and systems of this section, the method comprises filtering the plurality of objects by the server based on user defined or system defined filters related to the user's preferences and/or job function. In one embodiment of the methods and systems of this section, the AR or MR device is a head mounted display (“HMD”) device. In one embodiment of the methods and systems of this section, the HMD is structured to hold a client device comprising a processor, a camera, a memory, a software application residing in the memory, an IMU, and a display screen. In one embodiment of the methods and systems of this section, the HMD comprises a processor, a camera, a memory, a software application residing in the memory, an IMU, and a display screen.

The system optimizes the identification process by providing an algorithm with a list of objects that are known to be in the vicinity.

When a user enters into an area of work or unfamiliarity, the user can find objects needed to perform his/her function by allowing an identification algorithm provide a list of objects the user may be interested in based on the location of the user. The location may be based on GPS, RFID, WIFI, Smart Sensors or other location detection mechanisms. The system compares the location of the user to a database of objects and their locations. The system identifies a “radius of interest” that is, the area around the user in which the objects are of interest to the user. The radius of interest can be increased or decreased based on system or user settings. Once the system determines the objects in the area that may be of interest to the user, the system can either show the user a list of objects or highlight/identify the objects by overlaying identification information about the objects. The identification information of the object may be the name of the object floating on or near the object, highlight the object, increased lighting on or around the object, mark the object with a circle, arrow, or other mechanism, etc.

As the user moves, the radius of interest may change and the system identifies and marks new objects. The system may also remove the identification and/or marking from previously identified objects that are no longer in the area of interest.

An embodiment identifies a method for optimizing the identification of multiple objects that may be in the vicinity of a user as the user moves around in space (indoors or outdoors). Use location information of the user, the system can filter and therefore reduce the number of possible objects that may be in the user's vicinity. This reduces the processing power to actually “match” and identify the targets because the system need only look through the subset of objects that are in the user's vicinity.

An embodiment optimizes target recognition algorithms by reducing the set of objects that the system needs to recognize. An embodiment will benefit the training, operations and maintenance personnel since objects can be identified in real time and, once identified, the user can request further information about an object.

A first embodiment is a method for identifying objects in an area using augmented reality (“AR”). The method includes entering a radius of interest with an AR device, wherein the radius of interest comprises a plurality of objects. The method also includes identifying the radius of interest using a location detection means. The method also includes transmitting the location to a server. The method also includes comparing the location of the user and the location of each of the plurality of objects to generate to a list of objects within the radius of interest. The method also includes identifying the plurality of objects within the radius of interest to the user on a display screen of the AR device.

A second embodiment is a method for identifying objects in an area using mixed reality (“MR”). The method includes entering a radius of interest with a MR device, wherein the radius of interest comprises a plurality of objects. The method also includes identifying the radius of interest using a location detection means. The method also includes transmitting the location to a server. The method also includes comparing the location of the user and the location of each of the plurality of objects to generate to a list of objects within the radius of interest. The method also includes identifying the plurality of objects within the radius of interest to the user on a display screen of the MR device.

The method also preferably includes changing the radius of interest by moving to a new location. The method also includes comparing the plurality of objects to a list of objects provided by the user. The method also includes a client device in communication with the AR device.

The method also includes identifying the plurality of objects comprises overlaying identification information for each object of the plurality of objects.

The method also includes identifying and marking new objects. The method also includes filtering the number of objects of the plurality of objects. Filtering comprises using a target algorithm that reduces the number of objects of the plurality of objects.

The method alternatively includes filtering the plurality of objects by the server based on user defined or system defined filters related to the user's preferences and/or job function.

The location detection means is at least one of GPS, RFID, WiFi, magnetic fields, cellular triangulation or a location identification beacon.

The AR device is preferably a head mounted display (“HMD”) device. The HMD preferably comprises a processor, a camera, a memory, a software application residing in the memory, an IMU, and a display screen. The HMD is alternatively structured to hold a client device comprising a processor, a camera, a memory, a software application residing in the memory, an IMU, and a display screen.

A third embodiment is a system for identifying objects in an area using augmented reality (“AR”). The system comprises an AR head mounted display (“HMD”) device, a client device, a server, and a database. The client device is in communication with the AR device and the server. The client device is configured to identify a radius of interest using a location detection means when a user enters the radius of interest wearing the AR HMD device, wherein the radius of interest comprises a plurality of objects. The client is configured to transmit the location to a server. The server is configured to compare the location of the user and the location of each of the plurality of objects to generate to a list of objects within the radius of interest. The server is configured to identify the plurality of objects within the radius of interest to the user on a display screen of the AR HMD device.

A fourth embodiment is a system for identifying objects in an area using mixed reality (“MR”). The system comprises a MR head mounted display (“HMD”) device, a client device, a server, and a database. The client device is in communication with the MR device and the server. The client device is configured to identify a radius of interest using a location detection means when a user enters the radius of interest wearing the MR HMD device, wherein the radius of interest comprises a plurality of objects. The client is configured to transmit the location to a server. The server is configured to compare the location of the user and the location of each of the plurality of objects to generate to a list of objects within the radius of interest. The server is configured to identify the plurality of objects within the radius of interest to the user on a display screen of the MR HMD device.

The client device is preferably configured to detect a change in the radius of interest by moving to a new location.

The client device is preferably configured to compare the plurality of objects to a list of objects provided by the user.

The client device is configured to overlay identification information for each object of the plurality of objects. The client device is configured to identify and mark new objects. The client device is configured to filter the number of objects of the plurality of objects. The client device is configured to use a target algorithm that reduces the number of objects of the plurality of objects.

The virtual assets preferably comprises a whiteboard, a conference table, a plurality of chairs, a projection screen, a model of a physical object (e.g., jet engine, airplane, an airplane hanger, rocket, helicopter, customer product), a tool used to edit or change a virtual asset in real time, a plurality of adhesive notes, a projection screen, a drawing board, a 3-D replica of at least one real world object, a 3-D visualization of customer data, a virtual conference phone, a computer, a computer display, a replica of the user's cell phone, a replica of a laptop, a replica of a computer, a 2-D photo viewer, a 3-D photo viewer, 2 2-D image viewer, a 3-D image viewer, a 2-D video viewer, a 3-D video viewer, a 2-D file viewer, a 3-D scanned image of a person, 3-D scanned image of a real world object, a 2-D map, a 3-D map, a 2-D cityscape, a 3-D cityscape, a 2-D landscape, a 3-D landscape, a replica of a real world, physical space, or at least one avatar.

A HMD of at least one attendee of the plurality of attendees is structured to hold a client device comprising a processor, a camera, a memory, a software application residing in the memory, an IMU, and a display screen.

The client device of each of the plurality of attendees comprise at least one of a personal computer, HMD, a laptop computer, a tablet computer or a mobile computing device. A HMD of at least one attendee of the plurality of attendees is structured to hold a client device comprising a processor, a camera, a memory, a software application residing in the memory, an IMU, and a display screen.

The display device is preferably selected from the group comprising a desktop computer, a laptop computer, a tablet computer, a mobile phone, an AR headset, and a virtual reality (VR) headset.

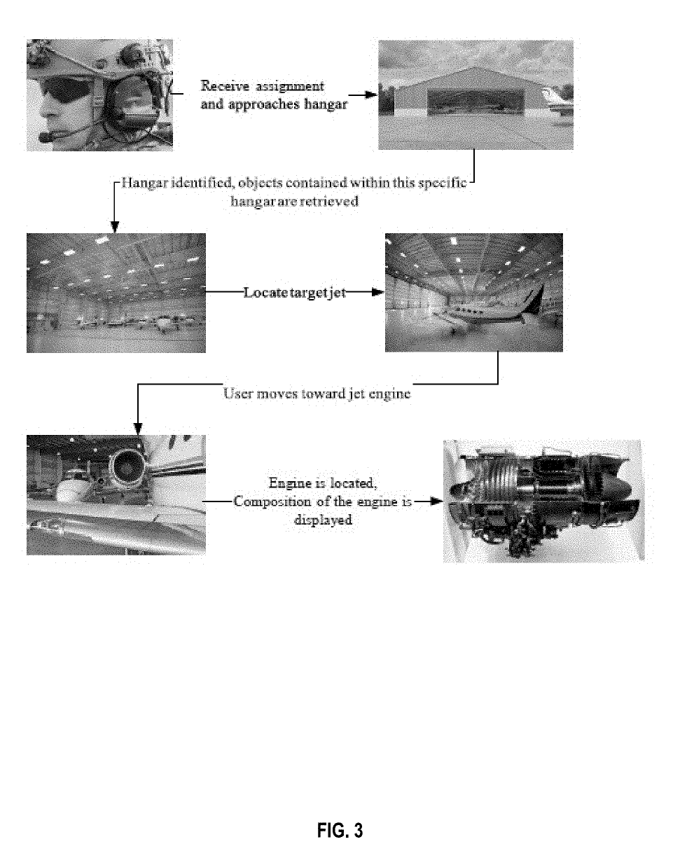

By way of example, FIG. 3 is a block diagram of system operation for filtering objects based on a location of the user in one embodiment.

The user interface elements include the capacity viewer and mode changer.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets. communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages. Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies. By way of example, a virtual environment in AR may include one or more digital layers that are superimposed onto a physical (real world environment).

The user of a user device may be a human user, a machine user (e.g., a computer configured by a software program to interact with the user device), or any suitable combination thereof (e.g., a human assisted by a machine, or a machine supervised by a human).

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

### Related Applications

This application relates to the following related application(s): U.S. Pat. Appl. No. 62/533,097, filed Jul. 16, 2017, entitled METHOD AND SYSTEM FOR FILTERING OBJECTS BASED ON LOCATION. The content of each of the related application(s) is hereby incorporated by reference herein in its entirety.

1. A method for identifying real objects in an area of interest for use in identifying virtual content a user is authorized to view using an augmented reality device, the method comprising:
determining a set of real objects that are near a first position of a first augmented reality device;
determining, from the set of real objects, a first subset of real objects that are associated with virtual content that the first augmented reality device is permitted to display; and
for each real object in the first subset of real objects, transmitting virtual content associated with that real object to the first augmented reality device.

2. The method of claim 1, wherein each real object in the set of real objects is near the first position when the first augmented reality device receives one or more signals containing identifiers that identify each of the real objects in the set of real objects.

3. The method of claim 1, wherein each real object in the set of real objects is near the first position when that real object is within a predefined distance from the first position.

4. The method of claim 1, wherein each real object in the set of real objects is near the first position when that real object is within a first area that includes the first position.

5. The method of claim 1, wherein each real object in the set of real objects is near the first position when a sensor of the first augmented reality device detects that real object.

6. The method of claim 1, wherein determining a first subset of real objects that are associated with virtual content that the first augmented reality device is permitted to display comprises:
determining a permission level of the first augmented reality device; and
for each real object in the set of real objects:
(i) determining if a permission level associated with the virtual content associated with that real object matches the permission level of the first augmented reality device;
(ii) if the permission level associated with the virtual content associated with that real object matches the permission level of the first augmented reality device, including the real object in the first subset of real objects; and
(iii) if the permission level associated with the virtual content associated with that real object does not match the permission level of the first augmented reality device, excluding the real object from the first subset of real objects.

7. The method of claim 1, wherein determining a first subset of real objects that are associated with virtual content that the first augmented reality device is permitted to display comprises:
determining a condition associated with the first augmented reality device; and
for each real object in the set of real objects:
(i) determining if the condition associated with the first augmented reality device matches a condition that applies to the virtual content associated with the real object;
(ii) if the condition associated with the first augmented reality device matches the condition that applies to the virtual content associated with the real object, including the real object in the first subset of real objects; and
(iii) if the condition associated with the first augmented reality device does not match the condition that applies to the virtual content associated with the real object, excluding the real object from the first subset of real objects.

8. The method of claim 1, wherein determining a first subset of real objects that are associated with virtual content that the first augmented reality device is permitted to display comprises:
determining one or more preferences of a first user operating the first augmented reality device; and
for each real object in the set of real objects:
(i) determining if a type of the virtual content associated with the real object matches at least one of the one or more preferences of the first user;
(ii) if the type of the virtual content associated with the real object matches at least one of the preferences of the first user, including the real object in the first subset of real objects; and
(iii) if the type of the virtual content associated with the real object does not match at least one of the preferences of the first user, excluding the real object from the first subset of real objects.

9. The method of claim 1, wherein determining a first subset of real objects that are associated with virtual content that the first augmented reality device is permitted to display comprises:
determining one or more filter settings designated for the first augmented reality device or a first user operating the first augmented reality device; and
for each real object in the set of real objects:
(i) determining if the virtual content associated with the real object passes the one or more filter settings;
(ii) if the virtual content associated with the real object passes the one or more filter settings, including the real object in the first subset of real objects; and
(iii) if the virtual content associated with the real object does not pass the one or more filter settings, excluding the real object from the first subset of real objects.

10. The method of claim 1, wherein the virtual content for each real object in the first subset of real objects includes a displayable name of that real object, and the method comprises:
displaying, on a display of the first augmented reality device, each name of each real object in the first subset of real objects.

11. The method of claim 1, wherein the virtual content for each real object in the first subset of real objects includes a displayable name of that real object, and the method comprises:
displaying, on a display of the first augmented reality device, a first name of a first real object at a position that appears to be within a predefined distance from the first real object.

12. The method of claim 1, wherein the virtual content for each real object in the first subset of real objects includes a displayable visual designator for that real object, and the method comprises:
displaying, on a display of the first augmented reality device, a first visual designator of a first real object at a position that appears to be on the first real object or within a predefined distance from the first real object.

13. The method of claim 1, wherein the virtual content for each real object in the first subset of real objects includes a virtual representation of internal components of the real object, and the method comprises:
displaying, on a display of the first augmented reality device, a first virtual representation of a first set of internal components of a first real object to overlay the first real object or at a position that appears to be within a predefined distance from the first real object.

14. The method of claim 1, wherein the method comprises:
receiving, from a first user of the first augmented reality device, one or more designations of one or more real objects; and
including, in the set of real objects, the one or more real objects designated by the one or more designations from the first user.

15. The method of claim 1, wherein the method comprises:
receiving, from a first user of the first augmented reality device, one or more designations of one or more real objects that are in view of the first user; and
including, in the first subset of real objects, the one or more real objects designated by the one or more designations from the first user.

16. The method of claim 1, wherein the method comprises:
receiving new virtual content generated during a first time period by a first user of the first augmented reality device;
determining a first real object from the first subset of real objects to associate with the new virtual content;
storing the new virtual content in association with the first real object;
transmitting, during a second time period, the new virtual content to the second augmented reality device; and
displaying, during the second time period, the new virtual content on a display of the second augmented reality device.

17. The method of claim 1, wherein the method comprises:
receiving new virtual content generated by a first user of the first augmented reality device in association with a first real object that is not included in the first subset of real objects;
storing the new virtual content in association with the first real object;
transmitting the stored virtual content to the second augmented reality device; and
displaying the new virtual content on a display of the second augmented reality device.

18. The method of claim 1, the method comprises:
determining that the set of real objects are near a second position of a second augmented reality device;
determining, from the set of real objects, a second subset of real objects that are associated with virtual content that the second augmented reality device is permitted to display; and
for each real object in the second subset of real objects, transmitting virtual content associated with that real object to the second augmented reality device,
wherein a first number of real objects in the first subset of real objects is different than a second number of real objects in the second subset of real objects.

19. The method of claim 1, wherein the first augmented reality device includes a head-mounted display or a mobile phone with a display for displaying virtual content the first augmented reality device receives.

20. One or more non-transitory machine-readable media embodying program instructions that, when executed by one or more machines, cause the one or more machines to implement the method of claim 1.
